(19) United States
(12) Patent Application Publication
(10) Pub. No.: US 2022/0253931 A1
(43) Pub. Date: Aug. 11, 2022

(54) COMPUTER SYSTEM

(71) Applicant: CARBEEZA LTD., Stony Plain (CA)

(72) Inventors: Sandro Antoni TORRIERI, Edmonton (CA); Glyn Devin READE, Edmonton (CA); Michael James Wilhelm DUNHAM, Edmonton (CA); Nicholas Joseph SAMAHA, Edmonton (CA)

(21) Appl. No.: 17/563,220

(22) Filed: Dec. 28, 2021

Related U.S. Application Data
(60) Provisional application No. 63/131,277, filed on Dec. 28, 2020.

(51) Int. Cl. G06Q 40/02; G06Q 30/06

(52) U.S. Cl. CPC G06Q 40/025; G06Q 30/0627; G06Q 30/0603; G06Q 30/0611

(57) ABSTRACT

A computer-implemented method comprising, by one or more hardware computer processors configured with specific computer executable instructions, receiving a set of customer parameters representing characteristics of a customer, accessing a catalog containing data on vehicles of a collection of vehicles to obtain vehicle parameters representing characteristics of specific vehicles of the collection of vehicles, generating deal data elements each representing a respective potential deal, each deal data element comprising an association between loan parameters and a vehicle of the collection of vehicles, operating a finance prediction AI on the deal data elements to predict responses of one or more lenders to the respective potential deals represented by the deal data elements for the customer, associating the deal data elements with evaluation scores representing evaluations of the respective potential deals according to an evaluation metric taking into account the predicted bank responses; and selecting a subset of the deal data elements based on the evaluation scores and displaying a visual representation of the respective potential deals represented by the subset of deal data elements on a display device.

### CROSS-REFERENCE TO RELATED APPLICATIONS

The present application claims all benefit including priority to U.S. Provisional Patent Application 63/131,277, filed Dec. 28, 2020, and entitled “COMPUTER SYSTEM”, the entirety of which is hereby incorporated by reference.

### TECHNICAL FIELD

Transaction implementation computer systems.

### BACKGROUND

Today in the automotive sales and finance space, there are software companies that already deal with many aspects of the process. This includes inventory management, lead and customer management, desking, and finance. While the intersection of these areas is straightforward for prime customers, the process is complex when it comes to non-prime customers. Consequently, non-prime deals are driven largely by intuition and guesswork, and as a result lenders incur more risk, both dealerships and customers are saddled with suboptimal deals, and dealerships and wholesalers hold onto stock that is not suited to their customer base.

It is desired to fill this gap by improving the customer-vehicle-lender triangle in both non-prime and prime retail sales, and by providing dealerships and wholesalers the tools to better manage their inventory, especially in the non-prime world.

### SUMMARY

In an embodiment, there is disclosed a computer-implemented method comprising, by one or more hardware computer processors configured with specific computer executable instructions, receiving a set of customer parameters representing characteristics of a customer, accessing a catalog containing data on vehicles of a collection of vehicles to obtain vehicle parameters representing characteristics of specific vehicles of the collection of vehicles, generating deal data elements each representing a respective potential deal, each deal data element comprising an association between loan parameters and a vehicle of the collection of vehicles, operating a finance prediction AI on the deal data elements to predict responses of one or more lenders to the respective potential deals represented by the deal data elements for the customer, associating the deal data elements with evaluation scores representing evaluations of the respective potential deals according to an evaluation metric taking into account the predicted bank responses; and selecting a subset of the deal data elements based on the evaluation scores and displaying a visual representation of the respective potential deals represented by the subset of deal data elements on a display device.

### BRIEF DESCRIPTION OF THE FIGURES

Embodiments will now be described with reference to the figures, in which like reference characters denote like elements, by way of example, and in which:

FIG. 1 is a diagram showing inputs and outputs for a computer system.

FIG. 2 is a diagram showing elements of an example system spread across multiple economic entities.

FIG. 3 is a flow diagram showing an example method.

FIG. 4 is a schematic diagram showing elements of a computer system.

FIG. 5 shows an example loading screen for an example customer-facing app.

FIG. 6 shows an example initial choice screen for an example customer-facing app.

FIG. 7 shows an example customer parameter entry screen for an example customer-facing app.

FIG. 8 shows an example vehicle filter screen for an example customer facing app.

FIG. 9A shows an example vehicle list screen for an example customer facing app.

FIG. 9B shows two entries from the example vehicle list screen of FIG. 9A.

FIG. 10 shows an example deal prediction screen for an example customer-facing app.

FIG. 11 shows an example information screen for an example customer-facing app.

FIG. 12 shows an example list screen for an example customer-facing app.

FIG. 13 shows an example auction start screen for an example customer-facing app.

FIG. 14 shows an example login/signup screen for an example customer-facing app.

FIG. 15 shows an example auction progress screen for an example customer-facing app.

FIG. 16A shows an example customer dashboard screen for an example customer-facing app.

FIG. 16B shows auction information from the example customer dashboard screen of FIG. 16A.

FIG. 17 shows an example results list screen for an example customer-facing app.

FIG. 18 shows an example results list screen for an example customer-facing app.

FIG. 19 shows an example credit pull authorization screen for an example customer-facing app.

FIG. 20 shows an example success reporting screen for an example customer-facing app.

FIG. 21 shows an example contact information screen for an example customer-facing app.

FIG. 22 shows an example initial screen for an example dealer-facing app.

FIG. 23 shows an example dealership selection screen for an example dealer-facing app.

FIG. 24A shows an example dealer dashboard screen for an example dealer-facing app.

FIG. 24B shows a bid card from the dealer dashboard screen of FIG. 24A.

FIG. 25 shows an example bid request listing screen for an example dealer-facing app.

FIG. 26 shows an example bid request listing screen for an example dealer-facing app.

FIG. 27 shows an example bid creation screen for an example dealer-facing app.

FIG. 28 shows an example VIN entry screen for an example dealer-facing app.

FIG. 29 shows an example configuration screen for an example dealer-facing app.

FIG. 30 shows an example feature selection screen for an example dealer-facing app.

FIG. 31 shows an example confirmation screen for an example dealer-facing app.

FIG. 32 shows an example aftermarket products screen for an example dealer-facing app.

FIG. 33 shows an example deal proposal screen for an example dealer-facing app.

FIG. 34 shows an example bid submission screen for an example dealer-facing app.

FIG. 35 shows an example bid acceptance screen for an example dealer-facing app.

FIG. 36 shows an example customer contact screen for an example dealer-facing app.

FIG. 37 shows an example neural network for tier prediction.

FIG. 38 shows an example neural network for lender approval prediction.

FIG. 39 shows the combination of the neural networks of FIGS. 37 and 38 to use the tier prediction output as input for the lender approval prediction.

### DETAILED DESCRIPTION

The PoweredByldeal™ system (herein, “Ideal”) is a set of cooperating engines that facilitate the purchase and funding of large-ticket items. In an example, the items are vehicles, but the items could be other purchases, especially purchases that are likely to be funded through a loan arranged in respect of the particular purchase. An initial implementation in particular focuses on the purchase and funding of vehicles in the Prime and Non-Prime markets. In this implementation it brings together customers, retailers, wholesalers, lenders, services providers (ie: inspection, maintenance, repair, detailing, and transportation), and streamlines traditional workflow to minimize guesswork and optimize various aspects of the transaction.

As part of this workflow, Ideal also enhances the audit capabilities of such transactions, such that improved visibility in the process is provided to Responsible Parties (business owners and controlling stakeholders in the process).

In this document, the term inventory and vehicle are used interchangeably. While the concepts apply to large-ticket inventory in general, the initial implementation specifically handles vehicles (including recreational, watercraft, and similar variants).

### Definitions

Responsible Party—A Responsible Party (RP) is the person or organization that has both the vested interest and authority to control key overall behaviors of Ideal, or portions of Ideal. These are typically the respective business owners, lending institutions, and other legal entities. Ideal operates on the principle of providing an RP with the tools to effectively control how their staff and organization operate, including the auditing of key information, while permitting the RP to optimize their business rules to their liking, within the confines of their regulatory frameworks.

Buyer—A person who conducts inventory purchasing for a dealer or wholesaler.

Specific Vehicle—Within this document, a Specific Vehicle is an instance of a particular physical vehicle.

Representative Vehicle—Within this document, Representative Vehicle identifies a group of vehicles where all vehicles share the same make, model, year, trim, style, and feature set and would be expected to be of approximately the same value excluding variation to do with mileage, condition, and similar wear factors.

Customer Tier—This is a broad categorization of customers that generally identifies how risky it is for Lenders to provide financing for a given customer.

Profit Mandate—This is a set of rules that controls the optimizations that will be conducted for a particular provider, such as a retailer or wholesaler. While profit earned on a specific vehicle is certainly one of the contributing factors, other factors are also considered including but not limited to the desire for return customers and the requirement to move aging stock. This weighting function is under the control of the respective dealership or wholesaler.

Profit Mandate Rating (PMR)—This is a dimensionless aggregate quantity that is used to express the desire to sell one vehicle compared to another, based on the rules defined in the Profit Mandate. While Ideal does not dictate compensation models for sales staff, it is intended that a compensation model that considers the PMR should result in the interests of sales staff being more aligned with the interests of the dealership than they might be otherwise.

Vehicle Damage Assessment (VDA)—This is an assessment, or the cash value of the assessment, of the outstanding damage on the vehicle that must be repaired before a retail sale can be completed.

Lender Decision Engine (LDE)—This is a subsystem that is used for predicting interactions with lending institutions.

Vehicle Evaluation Engine (V-EVAL)—This is a subsystem that is used to conduct vehicle valuations.

Advertisement—In the context of Ideal, an Advertisement is a notification from an Inventory Holder to either Retailers or other Inventory Holders as to the availability and price of stock that is currently held.

Wholesale Package—This is a collection of vehicles that are being sold as a single unit, sometimes known in the auction industry as a “lot”. A wholesale package always has a price for the entire package. When in a package, vehicles need not be priced individually. When vehicles are individually priced within a package, the sum of all vehicle prices may be higher, the same as, or lower than the package price.

Hold—A Hold is an expression of interest in a vehicle. It comes in two flavours, a Soft Hold and a Hard Hold, which have implications for the vehicle workflow. Soft holds will not always be permitted by an Inventory Holder.

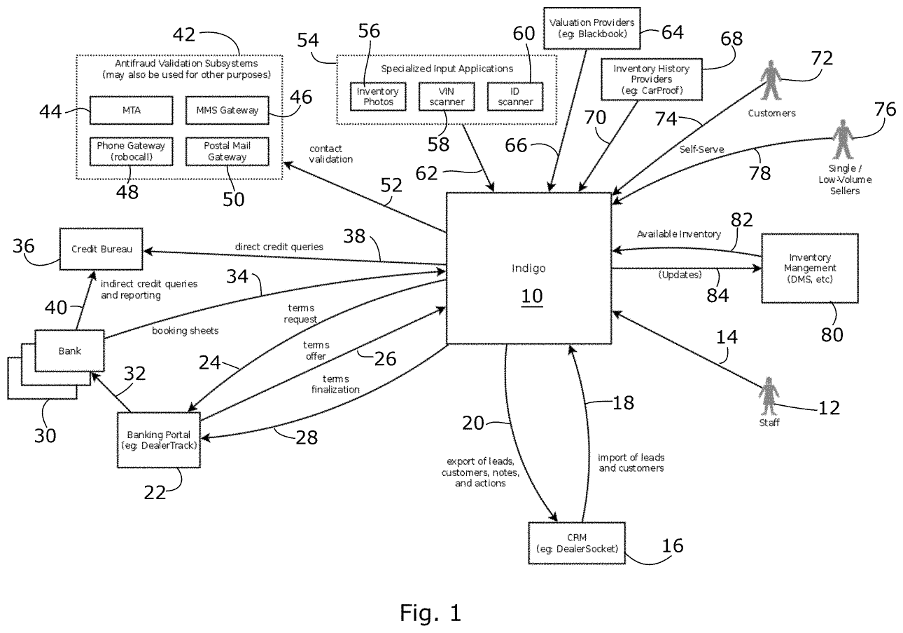

FIG. 1 is a diagram showing context for an example system as described in this document and information flows into and out of the system. As shown in FIG. 1, the system 10 interacts with plural other entities including: dealer staff 12 who may provide staff input 14; customer relationship management software 16 from which leads and customers may be imported in flow 18 and to which leads, customers, notes and actions may be exported in flow 20; a lending portal 22, such as for example DealerTrack™, to which a terms request can be sent in flow 24, from which a terms offer may be received in flow 26, and to which a terms finalization may be sent in flow 28; one or more banks 30, which may receive finance information in flow 32 from the banking (lending) portal 22, which flow may include flows 24-28 as relayed through the banking portal, and from which booking sheets may be received in flow 34; a credit bureau 36, to which credit inquiries may be sent directly by the system in flow 38, or from a bank in flow 40, which flow may also include reporting of credit information by the bank; antifraud validation subsystems 42 such as, for example, MTA 44, Multimedia Messaging Service Gateway 46, Phone Gateway 48, and postal mail gateway 50, which may receive flow 52 from the system 10 for antifraud validation of contact information and may also be used for other purposes; specialized input applications 54, such as inventory photos 56, VIN scanner 58, and ID scanner 60, which may send input to the system 10 in flow 62; valuation providers 64 (e.g. BlackBook™), which may provide valuation information in flow 66; inventory history providers 68, such as CarProof™ which may provide inventory history information in flow 70; customers 72, who may interact with the system 10 in a self-service arrangement via flow 74; single or low-volume sellers 76, who may interact with the system 10 in flow 78; and inventory management software 80, which may send information on available inventory in flow 82, and receive updates from the system 10 in flow 84. Not all flows and entities need be present in all embodiments and other flows and entities may also be present.

Stakeholders

The visible functions of Ideal differ depending on the perspective of the user. A brief list of the primary system stakeholders is included below. A given (real) organization may act as more than one stakeholder type; however for conciseness we consider the stakeholder types in isolation and then optimize for the cases where an organization holds more than one type organically.

Inventory Holder—This is any stakeholder which has inventory (here, vehicles) that they wish to sell. The typical Inventory Holders are either vehicle wholesalers or the inventory management group of retail dealers.

Retailer—This is a stakeholder that is primarily involved in orchestrating a retail Deal so as to marry up a customer with an appropriate vehicle and funding. As a side effect of this process, the Retailer will also orchestrate (but not necessarily perform) operations required to finalize the deal including arranging servicing, repair, detailing, and transportation involving the vehicle.

Customer—The customer is the stakeholder who intends to purchase a vehicle. This includes both individuals and organizations in personal and commercial transactions.

Lender—Lenders are those organizations (banks or other lending institutions) which provide financing for the Deal.

Services Provider—Services Providers are responsible for the completion of tasks associated with supporting vehicle sales (presale or postsale, retail or wholesale). They may either be organic to, or arms' length from, a dealership. They interact with Retailers and Inventory Holders through a tender model that allows a Retailer or Inventory Holder to delegate tasks to one or more Services Provider. The services in question include tasks such as inspection, maintenance, repair, detailing, and transportation of vehicles.

Root Provider—Within the system, there is exactly one (logical) Root Provider. This is the presence of Ideal Corporate. The Root Provider is responsible for the provisioning and deprovisioning of stakeholder organizations, coordination of key system parameters between other providers, collection of any metrics associated with system operation, collection/analysis/synthesis of data corresponding to inter-provider metrics/trends/predictions. In practice, the Root Provider may be implemented through a set of cooperating systems. A high level description of the functions observed by each stakeholder is described below.

Provider Function Overview

Ideal is structured around the concept of a federation of interacting autonomous Providers, where each Provider is optimized to best service its user base. For example, even though various aggregate metrics are shared throughout the system, a Retail Provider will try to optimize its own deals according the specifics of that business such as the specific customers, the inventory, backend product, and financing available, according to its defined Profit Mandate.

Providers interact with each other through a messaging subsystem that is capable of both point-to-point and broadcast communications. The communications patterns and types of messages vary with the type of Provider and its relation to other Providers in the system.

Providers also interact with external third-party systems (lenders, backend product providers, inventory management system, customer management systems, and so forth) for a variety of business logic purposes. The specifics of these interactions depend on the third-party system, but are often via web services, REST services, or batch file transfer.

The relationships between Providers are based on the relationships between the modeled business units. For example, although a dealership may purchase inventory from any wholesaler, in practice that dealership may normally obtain stock through a small subset of the available wholesalers.

Businesses may model most of their relationships on either a whitelist or blacklist basis. The differences are:

Blacklist

In a blacklist model, any provider will typically interact with any other suitable provider unless the relationship has specifically been marked otherwise. This, for example, would allow a dealership to obtain vehicles from any wholesaler including newly added wholesalers, unless an authorized person for that dealership has identified specific wholesalers which must be avoided.

The blacklist model is the most flexible in that as new Providers come online they become immediately available. It also requires the least initial and ongoing configuration, and is therefore the default model.

Whitelist

In a whitelist model, Providers will interact only with those other Providers that are explicitly identified. This, for example, would allow a dealership to say that they're only interested in using specific vehicle inspection companies.

Some types of relationships are always limited to either blacklist or whitelist models. For example, since a dealership always needs to establish a business relationship with a lender before that lender will provide funding, the Retailer-Lender relationship always follows the whitelist model.

In addition to the whitelist/blacklist behavior, inter-Provider relationships are also used to tune various business rules, such as what kind of discounts or incentives are offered, or the timing of various events or offers. (For example, a dealership may give a preference for scheduling vehicle maintenance with their organic service departments first, followed by preferred partners, before opening a tender request to any service centre.)

Root Provider

While other Providers in the system are intended to support one type of Ideal client or another, the Root Provider is the interface and control system through which Ideal staff interact, as well as acting as a central authority for various operations and data.

The Root Provider's subsystems provide for the major pieces of functionality as described below:

Synchronization of Key Data

In any distributed system, there must be an agreement as to the definition and semantics of certain key pieces of information. For example, at any given time the auto industry has a general understanding of the various makes, models, and styles that exist.

While some types of data is static and can be modified during normal software updates, some is dynamic and must have a common definition among all providers, regardless of whether that data is originated centrally or by a participating provider. The Root Provider acts as a common synchronization point for this kind of data.

Reference Sync Data Message Flow Diagram

Provisioning

Provisioning is, in essence, the way in which a dealership, wholesaler, services company, lender, or other business is onboarded into Ideal, as well as the orchestration of related changes or eventual retirement of the business. The Root Provider is responsible for the orchestration of this task.

Provisioning includes but is not limited to the following: Collection of appropriate Provider information (the company particulars, their type of operations, level of service, and so forth); and Controlling the full lifecycle of the software components and other resources necessary to support that Provider, including its connection to the system as a whole and the monitoring of active Providers.

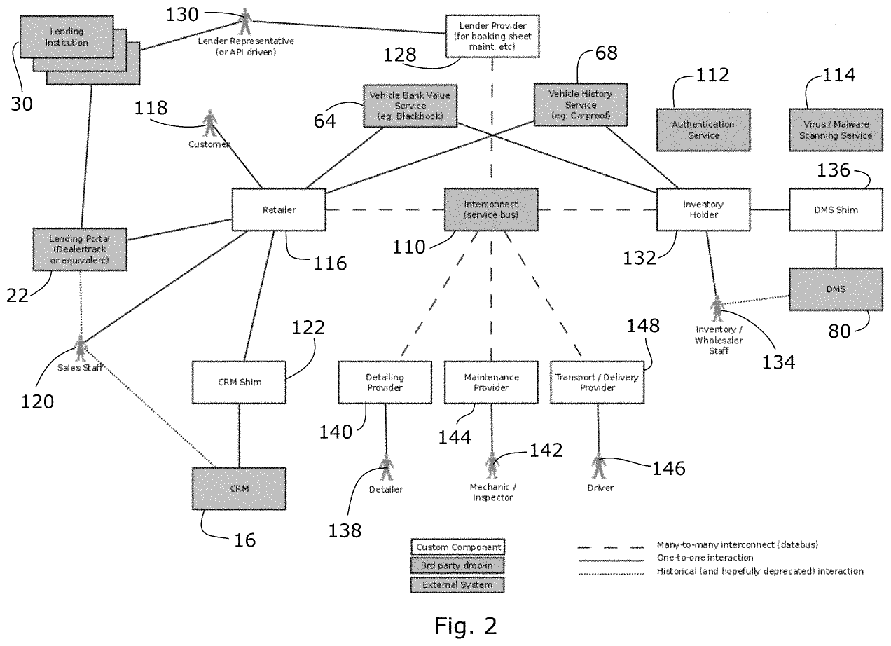

FIG. 2 is a diagram showing an example system including components that are controlled by different entities. As shown in FIG. 2, some system components may be custom components and others may be third party components. In the specific example shown in FIG. 2, an interconnect service bus 110, authentication service 112 and virus/malware scanning service 114 may be 3rd party drop-in components. Other grey boxes 16, 22, 30, 64, 68 and 80 show conventional third party components that are not considered part of the system but provide information to be used by the system. White boxes show elements that are custom components in this example. The interconnect service bus 110 may be, for example, an internet-based messaging service. A retailer component 116 may interact with a customer 118 and/or sales staff 120 at the retailer and also interact with a CRM shim 122 to interact with the retailer's customer relationship management software 16. The retailer component 116 may also interact with lending portal 22 which interacts with one or more banking institutions 30. There may also be a lending provider component 128 (for example for booking sheet maintenance as described below) that the bank 30 may interact with via a representative or API 130. An inventor holder component 132 may interact with inventory holder staff 134 and with the inventory holder's inventory management software 80 via DMS shim 136. A detailer 138 may interact with the interconnect 110 via detailing provider component 140; a mechanic 142 may interact with the interconnect 110 via maintenance provider component 144; and a driver 146 may interact with the interconnect 110 via transport/delivery provider component 148. The retailer 116, lender provider 128, detailing provider 140, maintenance provider 14, transport/delivery provider 148 and inventory holder 132 components may each interact via the interconnect 110 in a many-to-many interaction so that different combinations of each can come together to make a transaction work. The inventory holder component 132 and retailer component 116 may each interact on a one-to-one basis with valuation provider 64 and inventory history provider 68. The selection of which interactions are one-to-one and which are many-to-many may be varied in different embodiments, but in general, one-to-one interaction tends to occur between different items particularly owned by a single entity (e.g. different inventory holder components or retailer components) and unique entities that require special programming are also more likely to be interacted with on a one-to-one basis.

Collection and Analysis of Aggregate Statistics

While Providers collect and analyse data that is within their scope of visibility, some information is visible only to the system as a whole. The Root Provider provides for the collection and analysis of this system-level data and makes it available to the appropriate provider types in a fashion that does not expose business-sensitive or personally identifiable information in an inappropriate way.

Billing Metrics

The Root Provider is responsible for tracking and reporting on such metrics as is necessary to support Ideal's business model. For example, where Ideal is compensated on a per-transaction basis, the Root Provider is responsible for the collection and reporting transaction counts for each active Provider.

Inventory Provider

The Inventory Provider subsystem provides the functionality required to support those organizations which hold inventory. This is typically either a wholesaler or the inventory management department of a retailer (ie: dealership). Many clients will have their own 3rd party inventory control systems (DMSes), however the Inventory Provider subsystem is not intended to supplant these systems; it is intended augment a DMS when available in order to provide additional functions specific to Ideal. For cases where there is not a separate DMS, the Inventory Provider subsystem provides the minimum essential functions of a DMS.

The major functions of the Inventory Provider are described below.

Stock Ingest and Update

The Inventory Provider, in order to perform its other tasks, must have access to stock. Under normal circumstances, the Inventory Provider imports inventory data from a DMS, provides updates to that DMS (such as to mark a vehicle as unavailable when it gets purchased through Ideal, or when there is a change in the description of the vehicle), and accepts updates from the DMS (such as when the description or availability of a vehicle changes).

To facilitate situations where there is not an external DMS, or where the integration to the DMS is incomplete or otherwise unavailable, or needs to be augmented, the Inventory Provider has basic input/output capability, including batch import from sources such as CSV files or spread sheets.

Regardless of the data import capability, inventory data is validated upon import and invalid data will result in the specific records either being rejected or held in quarantine until they can be corrected.

In addition to basic vehicle descriptions, the Inventory Holder maintains other records that affect the saleability of the vehicle including damage, repair, inspection, and related records.

Reference DMS Sequence Diagram

Single Vehicle Sales

The Inventory Provider facilitates wholesale transactions of single vehicles between itself and Retailers or other Inventory Holders. The first stage of such a transaction is responding to vehicle requests from Retailers:

1. Listen for vehicle requests

2. Determine the whether or not to respond to the request based on whitelist/blacklist rules.

3. Identify the available vehicles that are consistent with the request.

4. Create a time-limited vehicle offer that is specific to the requesting Retailer.

5. Transmit vehicle offers to the requesting Retailer

The second stage involves the wholesale transaction itself, which can come in a few flavours:

1. Listen for counter offers, which may be accepted, declined, or result in an amended vehicle offer

2. Listen for hold requests, which may be accepted (perhaps subject to a deposit or other conditions) or declined

3. Listen for purchase orders, which may be accepted or declined (such as in the case where the stock is no longer available)

4. Listen for notifications of posting deposits or payments

5. Listen for cancellation of holds or purchase orders

Reference sales sequence diagrams. Or defer the retail one for the Retailer section?.

Wholesale Packages

An Inventory Holder has the option of grouping vehicles together in a Wholesale Package. Often this is used to try to move out unwanted stock by offering package price that is a discount from the sum of the individual vehicle prices, however the package price may also be equal to or greater than that sum.

Wholesale packages are sold on an all-or nothing basis. A vehicle may concurrently be part of more than one wholesale package, and may also be concurrently offered for sale as an individual sale.

If the Inventory Holder accepts a purchase order for a vehicle or a wholesale package, then any other package that contains that vehicle (or contains any other vehicles within the package to which the purchase order refers) are immediately invalidated; the remaining constituent vehicles of those invalidated packages may be used in other or new packages, but the invalidated packages are permanently unavailable.

Placing a hard hold on a vehicle will temporarily suspend any packages containing that vehicle. Vehicles on which an active hold has been placed cannot be used in the creation of new packages, nor in the creation of new vehicle offers, other than those which were created as a consequence of a counter-offer for a vehicle offer for which that vehicle was part.

An Inventory Holder will only advertise or provide Wholesale Packages to another Inventory Holder.

An Inventory Holder may create a Vehicle Offer for any vehicle that it holds, as well as a Vehicle Offer for a Retailer based on any available vehicle it sees in Wholesale Packages from other Inventory Holders, provided that the offer is for a single-vehicle sale.

In addition to allowing an inventory manager to create, maintain, and remove wholesale packages, the Inventory Provider supports building wholesale packages automatically, while still permitting a manager to provide final approval on those packages. In cases where packages get invalidated (such as a subset of constituent vehicles being sold outside that package), the Inventory Provider also provides mechanisms to roll the invalidated package's vehicles into a new package, ready for modification, rather than requiring the user to start again from the beginning.

Advertisements

Inventory Holders proactively let other providers know about available vehicles and wholesale packages. These come in the form of Advertisements.

While Advertisements can be sent to a subset of Retailers and Inventory Holders, their content does not contain any per-provider discounts or incentives. Given an Advertisement from another Inventory Holder, a Retailer or Inventory Holder can obtain a Vehicle Offer, perhaps containing discounts or incentives, by asking the other Inventory Holder for an offer based on the VIN.

Current Stock Valuation and Recommendations

Through the use of the Vehicle Evaluation Engine (V-EVAL) an Inventory Holder is able to obtain the estimated current and future value of a vehicle, its estimated financeability, and an indication of its suitability to different types of customers. From this, other factors can be identified such identifying the date after which minimum profit targets will not be met, the date after which the vehicle becomes a loss, and consequently the desirability of discounting the vehicle in order to move it before those dates.

Potential Stock Valuation and Recommendations

The same kind of calculations that are used to evaluate current stock can be used to evaluate stock that a buyer is considering for purchase. In addition to the usual valuations, this provides the buyer with information regarding potential profits, how quickly the vehicle must be moved, and whether it is likely to be appropriate to the types of customers that are expected in the near future.

Retailer

The Retailer (Provider) is one of the central Providers within Ideal. It is responsible for orchestrating retail transactions and associated workflows. The retail transaction workflow is broken down into two variants, non-prime and prime, the latter including cash transactions. These two variants differ most significantly in how financing must be arranged for the deal.

Retail Purchase (Non-Prime)

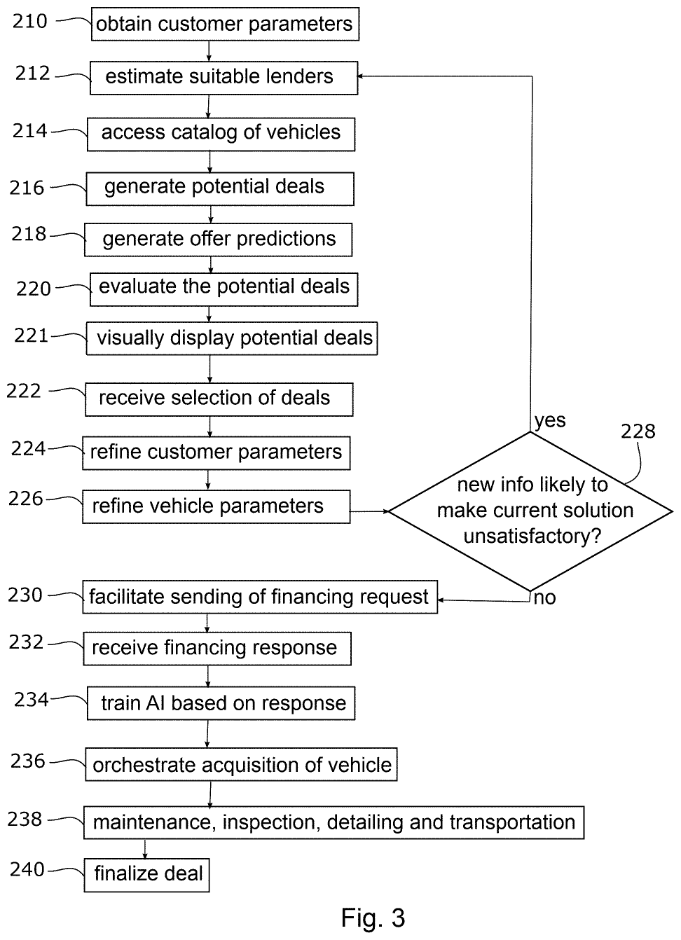

A retail non-prime purchase consists of the following major stages, each of which will be described in greater detail and illustrated in FIG. 3. It should be noted that many of these occur in an iterative fashion; as the quality of information improves for initial stages, the derived data in later stages is updated:

1. In step 210, obtain a set of customer parameters representing characteristics of a customer.

2. In step 212, conduct an initial estimate of suitable lenders, based on the customer parameters, for the purpose of narrowing the scope of the vehicle search.

3. In step 214, query Inventory Holders for suitable vehicles, without identifying the specifics of the customer, deal, or potential lender.

4. In step 216, generate potential deals for the customer using the available vehicles.

5. In step 218, using a finance prediction AI, assess a probability that a lender will provide financing for the potential deals.

6. In step 220, evaluate the potential deals in the context of the set of available lenders and provide a visual display of at least some of the potential deals in step 221.

7. In step 222, permit the user to select specific vehicles for further analysis and comparison. This includes providing initial recommendations to the user for suitable back end products and estimates of all-in costs.

8. In step 224, refine the quality of customer information, including personally identifiable information, allowing for credit pulls and related operations.

9. In step 226, if necessary, refine information about the vehicle in question including obtaining detailed vehicle history and additional valuations.

10. In step 228, iterate over the above process, potentially considering different vehicles and lenders, until a satisfactory vehicle and funding combination is obtained (or it can be determined that there is no combination that is appropriate to this customer).

11. In step 230, permit the user to send financing requests to selected lenders, and facilitate that transaction.

12. In step 232, receive financing response from lender.

13. In step 234, train the finance prediction AI based on the financing response.

11. In step 236, if necessary, orchestrate the acquisition of the selected vehicle from the Inventory Holder.

12. In step 238, if necessary, orchestrate the maintenance, inspection, detailing, and transportation of the vehicle.

13. In step 240, orchestrate the finalization of the deal, including post-delivery tasks.

We discuss some of these stages in more detail, below.

Step 210—Obtain Customer Information

Non-prime workflow starts with obtaining at least minimal information on the customer, such as the amount that they would like to make in regular payments and their current income. Ideally, the customer also provides a guess as to their credit worthiness (or takes an alternate workflow where their credit worthiness can be determined).

Any level of customer information beyond the minimum, up to and including fully identifying the customer and obtaining their credit history, serves to refine the process and provide better estimates in later stages.

If the customer is planning on providing a vehicle for trade-in, the trade-in information may also be collected.

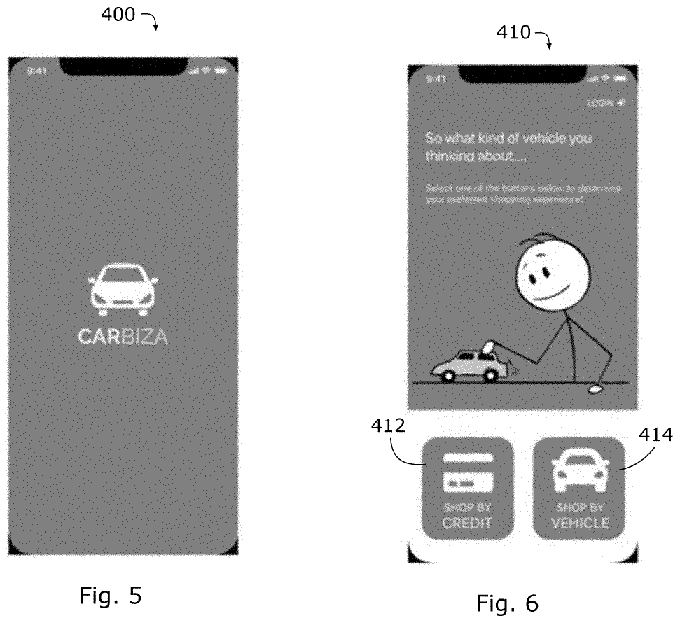

These customer parameters enter the system via an input channel such as a user interface or an internet connection. They may be entered by a customer directly or for example by a retail employee based on communication with the customer. An app by which information may be entered by the customer is described below in relation to FIGS. 5-36, with customer-facing aspects described in relation to FIGS. 5-21.

In situations where not even the payment and income is available, the transaction may be treated as a prime retail purchase and later refined.

Step 212—Limit Lender Programs

Depending on the customer information provided, some lender programs may be immediately eliminated from consideration. This is typically done based on hard lender rules and known information about the customer. Some examples as to why a program may be eliminated from consideration include:
The customer has credit circumstances or events (late payments, bankruptcies, excessive debt to income ratios) that are contrary to the lender program's requirements.
The customer is new to the country, and the program does not cover recent immigrants.
The customer is outside of the lender's service areas.

Any lender programs so eliminated may be reconsidered in light of updated customer information.

The finance prediction AI, described below, may also be used to eliminate lender programs if a customer is unlikely to be accepted into a program despite being within hard rule bounds.

Step 214—Search for Available Vehicles

After obtaining basic customer information, a Retailer will send a search request to all or a subset of Inventory Holders in order to obtain suitable Vehicle Offers. The user is permitted to specify the obvious set of search criteria including but not limited to body type, year, make, model, style, trim, and feature sets. In addition to user specified criteria, the Retailer may include over override criteria based on customer criteria. For example, if a suitable wholesale price cap can be determined based on the customer's circumstances and the dealership's Profit Mandate, the maximum price limit is set in the search criteria.

It should be noted that at no time is information on a customer or specific deal shared with any Inventory Holder.

The Retailer then waits for a limited amount of time to receive Vehicle Offers from Inventory Holders. Those offers received in time may be immediately saved and considered; those received after the time limit has expired may be saved at the Retailer for later consideration.

When sending a search request to Inventory Holders, the Retailer may scope the requests in a few different ways including but not limited to:

1. querying only the Retailer's directly assigned Inventory Holder (ie: searching a dealership's own stock);

2. querying any Inventory Holder that is within the same organization as the Retailer;

3. querying any Inventory Holder that is within a particular geographic area;

4. querying Inventory Holders that have predefined business relationships with the current Retailer; and

5. querying all Inventory Holders.

An alternate-path search mechanism may also be used in that a Retailer may, instead of querying Inventory Holders, it may limit its search to locally stored non-expired Vehicle Offers that it has previously received from various Inventory Holders.

The databases of the Inventory Holders queried are collectively referred to as a catalog.

Step 216—Generate Potential Deals

Once vehicle offers are obtained, a deal generator generates deal data elements representing potential deals on vehicles considered, which may be a subset of the total collection of vehicles, for example based on the vehicle selection criteria chosen by the customer. Each deal data element may comprise an association of a vehicle with loan parameters. The deal data element may also comprise additional associations such as with a particular set of backend products.

The deal generator may generate a single potential deal for each vehicle, or multiple potential deals for each vehicle. The deal generator may be tightly coupled or integrated with the finance prediction AI and the evaluator described below. This tight coupling may be used to improve the quality of deals generated, particularly where only a single deal is generated per vehicle in an iteration of this process.

Step 218—Predict Loan Offers

Once a selection of potential deals is generated, an initial prediction is made by a finance prediction AI as to what loan offers various lenders may make under their respective programs. For this process, in an embodiment at least the following is determined by the deal generator for each vehicle considered:
the payment call (loan parameters such as amortization, term, rate, finance amount, cost of financing)
a recommended set of backend products

and the finance prediction AI may operate on this data to provide an offer prediction indicating a likelihood that the lender would eventually fund this vehicle for this customer.

Step 220—Evaluate Potential Deals

The likelihood that the lender would eventually fund this vehicle for this customer is one example of an evaluation metric. An evaluator may receive the deal data elements and associate the deal data elements with evaluation scores according to further evaluation metrics. Examples of such further evaluation metrics include:
profit breakdowns (front end, back end, total)
the Profit Mandate Rating (PMR)

Each element of a profit breakdown, the likelihood of funding and the PMR is an evaluation metric. Any combination of evaluation metrics is also an evaluation metric. The value determined for a particular potential deal according to an evaluation metric is an evaluation score.

In an embodiment, the potential deals are ranked on a combination of the funding likelihood and the PMR, and displayed to the user in step 221.

In one embodiment, all possible deals considered are displayed to a user ranked according to their evaluation scores obtained according to an evaluation metric. In another embodiment, a subset of potential deals are selected for display based on the evaluation scores, for example all potential deals above a threshold score or with a score corresponding to a threshold rank or better. The subset may be, for example, deals shown in an initial page of results, and further results may be available to a user by scrolling or other input. In another embodiment, the display may show potential deals visually associated with their evaluations according to one or more evaluation metrics.

The evaluator is connected to an output channel for transmitting representations of the potential deals, and any associated information, to the display. Depending on the embodiment, the display itself may be external to the system.

Step 222—Select Vehicles and Process Worksheets

From the potential deals presented, for example the group of ranked vehicle offers, the user is permitted to select multiple vehicles of interest and the lenders that should be contacted for obtaining actual loan offers. This level of detail is represented by worksheets (one worksheet per customer/vehicle/lender combination.)

During this process, the user is able to modify aspects of the worksheet such as payment amounts and frequency, and downpayment amount.

Also at this time, in step 224 the level of customer information must be expanded to a level that is suitable for submitting to an actual lender, should it not already have been provided. In cases where we are using a direct connection to credit reporting agencies, the customer's credit is also pulled at this stage. In step 226, if necessary, refine information about the vehicle in question including obtaining detailed vehicle history and additional valuations.

During this process, the user may iterate on previous steps, as represented by decision box 228, should the expanded information indicate that the vehicle is no longer an optimal choice.

Step 230—Request Financing, Solidify Vehicle Selection and Deal Details

Once there is sufficient identifying information on the customer, the vehicle selection has been made and the deal details predicted, the lending institution(s) is contacted with a funding request. This starts the next stage of the iterative process with the objective of obtaining a booked deal. Within Ideal, this process is handled by way of Lender Proxies (not to be confused with the Lender Provider), and which are internal to the Retailer implementation.

This process may involve placing vehicle holds with the sourcing Inventory Holder or committing (as the Retailer) to the wholesale purchase of that vehicle from the Inventory Holder, either singly or as part of a wholesale package.

Those vehicles and funding requests that are not used in the final booking of the deal are released or retired, respectively.

Step 232—Receive Financing Offer from Lender

When a response is received from the lender, which may comprise an approval, including a choice of customer tier, or a declining of the funding request, the response may be forwarded to the customer and may also be used to train the finance prediction AI in step 234.

Step 236-240—Vehicle Acquisition and Post-Booking Actions

Once the Retailer has committed to the wholesale purchase of the vehicle from the Inventory Holder (which does not necessarily correspond to the time that the deal is booked), the Retailer completes this interaction with the Inventory Holder in step 236.

Before the vehicle can be delivered to the customer, there is usually a set of actions that must be performed on the vehicle in step 238, including but not limited to maintenance, repairs, inspection, detailing, as well as the movement of that vehicle, as required, from the sourcing Inventory Holder, through the appropriate service Providers, and eventually to the customer. The Retailer is responsible for initiating these actions, either by placing a direct work order or placing the work out for tender and finalizing that tender. In both cases, the Retailer is responsible for tracking the status of the Post-Booking work and eventual delivery of the vehicle in step 240.

Retail Purchase (Prime and Cash Sale)

The prime and cash retail purchase workflows are degenerate cases of the non-prime workflow.

In both cases, one major difference is that the initial user interaction is at the point of searching for vehicles, which means that the search must be able to proceed without any information at all regarding the customer. This further implies that any displayed prices are either cash prices (for cash deals) or marked as “as low as”-type prices based on the best possible credit tier (for financed prime deals).

In the cash sale case, any lender specific workflows are obviously bypassed.

At the point in a financed prime deal that hard customer information is being collected, there is no substantive difference in workflow between the prime and non-prime financed cases.

Lender

The primary workflow of the Lender provider is to provide the operating parameters that describe the rules under which the lenders will provide funding. In business terms, this is the entry and upkeep of the lender booking sheets (booking sheet maintenance as mentioned in relation to FIG. 2) which are common to all dealerships within a region, as well as general information on their offerings such as the set of available tiers. This can either be via manual entry from a lender representative, or as an automated data import from a cooperating lender information system. The information could also be manually entered by someone else, such as for example an Ideal employee, based on information provided by the lenders.

A secondary workflow is the management of conditions and incentives from a Lender that are applicable to a specific Retailer.

Services Provider

In both the pre-sales and post-sales cases, vehicles will typically require some sort of services to be performed. This can include maintenance, inspection, repair, detailing, transportation of the vehicle, and similar services.

A Services Provider can offer all or a subset of these kinds of services. Often dealerships will have an in-house (organic) service centre that acts as a Services Provider, and sometimes it is outsourced to an external party. Ideal allows a dealership to use both organic and external Service Providers, and do so in a fashion where different services could be fulfilled by different providers, through the use of a tender system.

The primary operations of a Services Provider are:

1. Listen for tender requests

2. Evaluate and recommend as to whether or not the tender request should be actioned.

3. In cases where an automated tender submission is feasible, broker that submission.

4. If a tender is granted and a third party service scheduling application is in use:

1. Provide enough information the third party scheduler is able to action the tender.

2. Obtain from the third party scheduler tender completion or alteration information.

5. If a third part service scheduling application is NOT in use:

1. In preparation of submitting a tender, allow staff to create, estimate, and schedule supporting tasks.

2. In the processing of an accepted tender, allow staff to create, update, or delete supporting tasks.

3. In the processing of an accepted tender, allow staff to update the status and other related information on the tender.

6. Propagate tender completion and related information back to the issuing Provider.

7. Provide for the extraction of summary information suitable for billing.

System Description

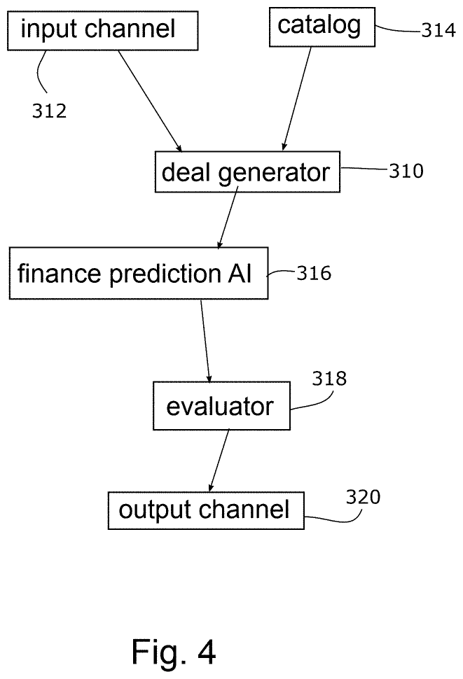

A system as described here is shown schematically in FIG. 4. A deal generator 310 may be connected to an input channel 312 and a catalog 314 containing data on vehicles in a collection of vehicles to generate deal data elements each representing a respective potential deal, each deal data element comprising an association between loan parameters generated by the deal generator and a vehicle of the collection of vehicles. A finance prediction AI 316 may be connected to the input channel 312 and to the deal generator 310 to generate offer predictions predicting responses of one or more lenders to financing requests for the potential deals represented by the deal data elements for the customer. An evaluator 318 may be connected to the finance prediction AI to generate evaluation scores for the deal data elements representing potential deals on vehicles of the collection of vehicles, based on evaluation scores for the potential deals according to an evaluation metric taking into account the offer predictions and may select a subset of the deal data elements based on the evaluation scores. The evaluator 318 may be connected to an output channel 320 for transmitting representations of the subset of potential deals for visual display or for transmitting a representation of the potential deals visually associated with their evaluations according to the one or more evaluation metrics. When one element is connected to another, this connection may be direct or indirectly via another element.

Subsystem Descriptions

Vehicle Evaluation Engine

The Vehicle Evaluation Engine (V-EVAL) is a subsystem by which a Specific Vehicle or a Representative Vehicle may evaluated as to its estimated current value and estimated future values, as well as the financeability of that vehicle. The results of the V-EVAL are used by Retailers for trade-ins, and by Inventory Holders for both assessing current inventory and evaluating potential purchases.

Valuations

The primary valuation mechanism is one of considering a group of Valuation Sources, and calculating a

weighting function across that group of Valuation Sources, where the weighting function can be customized on a per-user basis.

A Valuation Source is responsible for examining all the known information, and the set of unknown information, regarding a vehicle and providing:

1. An estimate of the current value of that vehicle.

2. The value adjustments that are applicable for that vehicle. A value adjustment is a modification to the baseline price of a vehicle.

3. The set of value adjustments that the source is able to apply in general.

It may also optionally provide:

1. The estimated error of the current value;

2. A set future values; and

3. Estimates of the error in future values.

The set of Valuation Sources includes, but is not limited to:

1. Historical records of Representative Vehicle values seen in Ideal wholesale transactions.

2. Historical records of Specific Vehicle values seen in Ideal wholesale transactions (for those vehicles that have previously been sold within Ideal by or to the estimating organization).

3. 3rd party sources of Representative Vehicle retail or wholesale value (eg: Canadian Blackbook, Kelley Bluebook)

4. 3rd party sources of Specific Vehicle retail or wholesale value (eg: Carproof)

5. An optional “self-swag” source, whereby an experienced user is able to provide a valuation guess.

In addition to the value adjustments provided by Valuation Sources, the V-EVAL also has a set of standalone Valuation Adjusters. These Valuation Adjusters include but are not limited to:

1. A configuration adjuster, where the value is modified based on the specific vehicle type and configuration and their historical effect within Ideal

2. A regional adjuster, where the value is modified based on the region of sale.

3. A seasonal adjuster, where the value is modified based on annual cycles.

4. A damage adjuster, whereby the cost of identified current repairs may be estimated based on historical records of similar types of damage on equivalent vehicles.

The standalone Valuation Adjusters may be used by the V-EVAL to modify results of Valuation Sources where those sources do not already perform the equivalent operation.

Based on the Valuation Sources and Valuation Adjusters, the V-EVAL merges the valuations according to a user-defined weighting function. The parameters of the weighting function include:

1. The contribution that should be made by the source, relative to other sources, for the current value.

2. The contribution that should be made by the source, relative to other sources, for future values.

The merged valuations include both current and future value estimates. In providing the merged valuations, the V-EVAL also provides statistical measures, numerically and graphically, of the merged valuations including deviation, related error estimates, and measures of the contributing sources.

In addition to the individual and merged valuations, V-EVAL also maintains correlation statistics in order to identify potential dependencies between the valuation sources which may bias the merged valuations.

While the V-EVAL provides estimates for current and future values, the end user is able to override the accepted value. In doing so, Ideal maintains all values, calculates and shows differences and deviations, and may require the user to provide justification for the override, for audit and analytical purposes.

Financeability

While the current and future value of a vehicle is useful for current stock, it provides only part of the picture when it comes to vehicle acquisition, including trade-ins, in the non-cash and particularly nonprime market. The other major factor is the financeability of the vehicle, which is not only a factor of the vehicle, but also of the likely future customer and lender.

V-EVAL fulfills this function with assistance from the Lender Decision Engine (LDE), with the latter running in a mode that is not necessarily examining specific deals or customers. In this mode, LDE makes predictions based on categories of clients. This provides V-EVAL with a set of financeability numbers for the vehicle, one for each applicable client category, based on the most likely lenders for those client categories.

Lender Decision Engine

Conducting any type of interaction with an actual Lender uses resources of that Lender, in many cases requires human interaction, may impact the Lender's willingness to partner with the Retailer, may increase costs to the Retailer, and in all cases requires stringent auditing mechanisms.

The Lender Decision Engine (LDE) is a subsystem that provides the following principle functions:

1. Predict, within the bounds of Ideal, how a lender will react to various transactions, should those transactions actually be initiated.

2. Act as a proxy to the actual Lender transaction system, or a 3rd party system supporting the Lender, in order to insulate the rest of Ideal from Lender-specific rules and interactions and broker the business transactions.

The LDE's role as a proxy to the actual Lender transaction system is only ever used in the context of a Retailer. The LDE's predictive functions can be used in the context of both a Retailer or an Inventory Holder, however the type and quality of information available to the LDE in those two cases will generally differ.

Predictions

Preapproval Predictions

A preapproval prediction encompasses the information that we expect a lender would provide, should one seek an actual financing preapproval. This does not look at parameters surrounding particular vehicles, but rather focuses on aspects of the client (employment status, credit history, and other factors). The key information that it provides includes the maximum loan amount, the maximum term and amortization, interest rate, as well as additional Ideal-specific information such as likelihood of the lender making such a preapproval and likelihood estimators for the accuracy of the predictions.

The preapproval prediction, when created for a specific client, helps bound the set of suitable vehicles for that client.

When used outside the context of a specific client, such as when an Inventory Holder is calculating vehicle evaluations, the preapproval predictions assist in assessing the financeability of a vehicle for customers of different tiers. It therefore is part of the workflow whereby classes of vehicles can be targeted by buyers to fulfill expected customer demand, as well as predicting potential profits of specific vehicles should those vehicles be acquired.

Offer Predictions

An offer prediction encompasses the information that we expect a lender would provide, should one seek an actual financing approval for a given vehicle. The LDE uses preapproval predictions, combined with vehicle information, lender booking sheets, historical Ideal transactions, and related information to create this prediction. The offer prediction includes much of the same information as a preapproval, updated for a specific vehicle, as well as additional information such as profit breakdowns.

Transactions

Financing Request

A financing request encompasses the information that is submitted to a lending institution for a particular vehicle for a particular deal.

Finance Offer

A finance offer encompasses the information that is obtained from a lending institution for a particular vehicle for a particular deal, and includes the concept of a negative offer (decline) or offer-plus-additional-conditions.

Finance Message

A finance message is a message (consisting of body and metadata) that travels bidirectionally between Ideal and the Lender's system to facilitate unstructured but official communication between the Lender's staff and the Retailer's salesperson, within the context of a specific deal.

Services Scheduling Engine

Once a vehicle has been booked, there are typically additional actions that must be taken before the vehicle can be handed over to the customer. For example:

1. The vehicle may not be at the local dealership, and may in fact be at the location of another dealer or wholesaler.

2. The vehicle may need maintenance or repairs to be performed.

3. The vehicle will typically need to be inspected for the jurisdiction in which it is being sold.

4. The vehicle may need to be detailed (ie: cleaned)

5. The vehicle may have to be moved from its current location, to one or more locations where the above services can be performed.

6. The vehicle may need to be delivered to the customer at a location other than the Retailer's place of business.

It is the Retailer's responsibility, specifically that of the conducting salesperson, to schedule these additional items. The salesperson's job, however, is simplified by Ideal detecting required tasks. For example, if a vehicle has a nonzero VDA, repairs may be required; it may be a dealership's standard to always perform an oil change before a car is released; an inspection if the vehicle is likely required if it has not already passed a recent inspection. And based on these items, where the vehicle originates, where any work has to be performed, and where the vehicle must be delivered, the system can assist in scheduling transportation.

Assisting in these tasks is the Services Scheduling Engine (SSE). The primary responsibilities of the SSE in a retail sale are:

1. Identify mandatory and recommended pre-delivery tasks.

2. Allow the salesperson to add optional pre-delivery tasks.

3. Determine the initial sequence and target dates for the pre-delivery tasks.

4. Allow the salesperson to modify the sequence and target dates of the pre-delivery tasks.

5. Allow the salesperson to alter the recipients of task tenders.

6. Send out task tenders to the appropriate service (maintenance, detailing, or transportation) providers.

Determining the recipients of task tenders comes in three different approaches:

1. Sending tasks to service providers that are organic to the Retailer's organization.

2. Sending tasks to service providers with which the Retailer has established business relationships

3. Sending tasks to other service providers, perhaps within specific geographic regions.

As with the Retailer/Inventory Holder interactions, a given provider can alter the distribution or receipt and acknowledgement of task tenders through a whitelist or blacklist mechanism.

App

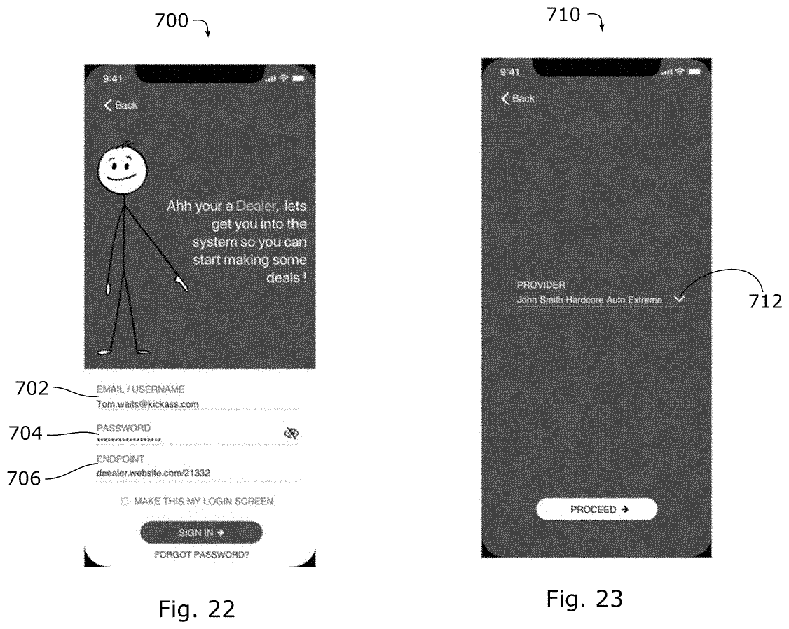

An app or webpage may be used to allow dealers and customers to interact with the system and with each other. FIGS. 5-36 show example screens for such an app. Although presented as a cellphone app, the same features could be implemented in, for example, a webpage or desktop application. FIGS. 5-21 show example screens for a customer and FIGS. 22-36 show example screens for a dealer. The dealer and customer screens may be presented in the same app or application for different users depending on information entered, or may be presented in different apps or applications. In the embodiment shown, the dealer and customer screens have different colour schemes (here purple for the dealer and blue for the customer).

FIG. 5 shows an example loading screen 400 for a customer. FIG. 6 shows an example initial choice screen 410 giving options to the customer, for example a shop by credit option 412 and a shop by vehicle option 414. If selected, the shop by credit option 412 will lead to a flow of screens in which the customer is presented with a variety of vehicles appropriate to the customer's budget and credit score. The flow of screens presented here is for the shop by vehicle option 414.

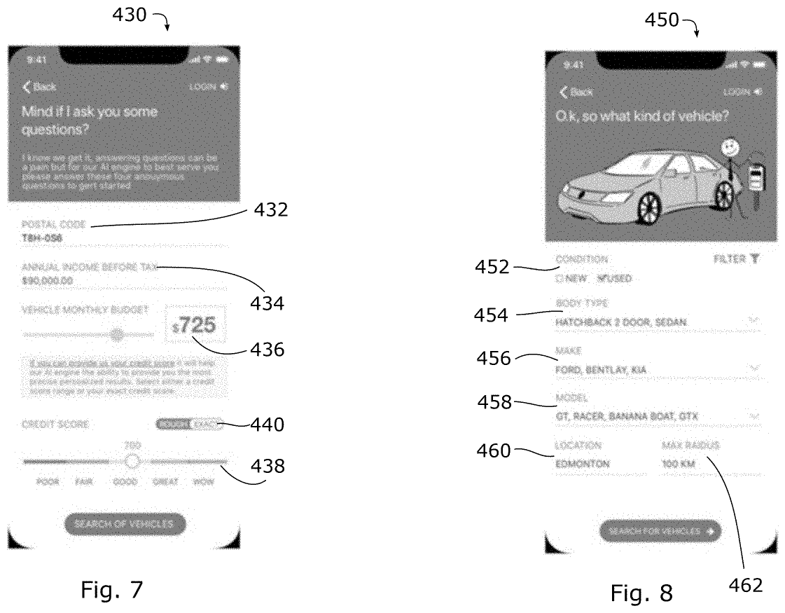

FIG. 7 shows a customer parameter entry screen 430 having, in this example, a postal code data entry field 432, an income data entry field 434, a monthly vehicle budget data entry field 436, and a credit score data entry field 438. The customer parameter entry screen allows the customer to provide these customer parameters to the system, as indicated in step 210 of FIG. 3, to begin the AI estimation of suitable lenders, as indicated in step 212 of FIG. 3. The credit score data entry field 438 may include an option 440 to indicate whether the credit score is known exactly or is a guess. This screen or another screen may also provide the customer with an option for the customer to authorize the system to retrieve the credit score from a credit reporting agency, e.g. Equifax™.

FIG. 8 shows a vehicle filter screen 450 to allow the customer to filter on various vehicle characteristics. For example, the vehicle filter screen can include a condition filter 452, a body type filter 454, a make filter 456, model filter 458, location filter 460 and distance filter 462. Filters may optionally be left blank. Based on the filter selections, the system may access a catalog of vehicles as indicated in step 214 of FIG. 3, generate potential deals using the customer parameters and vehicle characteristics as indicated in step 216 of FIG. 3, generate offer predictions as indicated in step 218, and evaluate the potential deals as indicated in step 220 of FIG. 3. The catalog of vehicles can include inventory of dealers who have made their inventory information accessible to the system, but can also include other sources such as a Kijiji™ search.

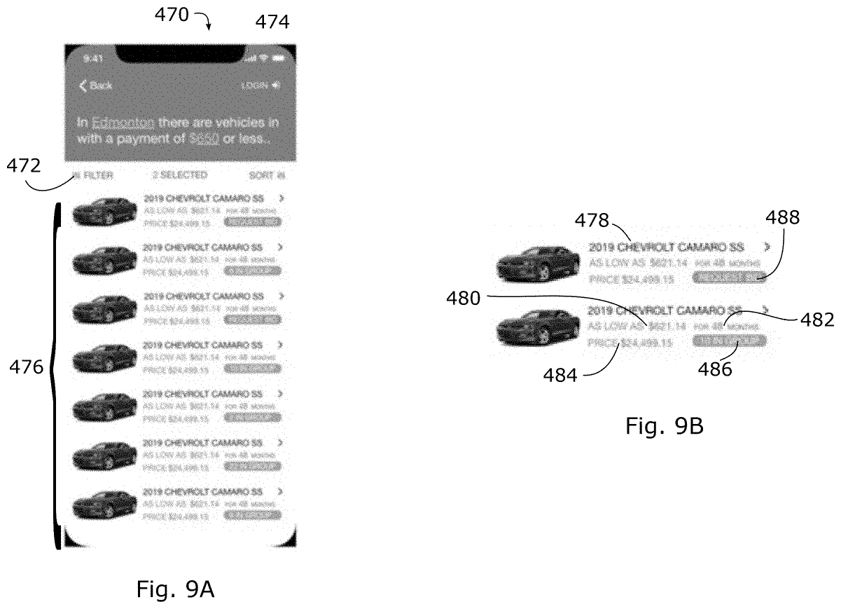

FIG. 9A shows a vehicle list 470. The list may include filter options 472 and sort options 474. Sorting may be by evaluation of potential deals or by other characteristics. The list may be formed of entries 476. To reduce clutter, similar vehicles may be grouped together under a single list entry. FIG. 9B shows two entries 476 from the vehicle list 470 of FIG. 9A Information shown for each list entry can include a vehicle type 478, monthly payment 480, loan duration 482, price 484, and number 486 of individual vehicles to which the list entry corresponds. For entries corresponding to single vehicles, a bid request option 488 may be provided. For entries corresponding to multiple vehicles, a customer may click on the entry to see a sub-list (not shown) where the customer may request bids on vehicles in the sub-list and return to the list shown in FIG. 9A.

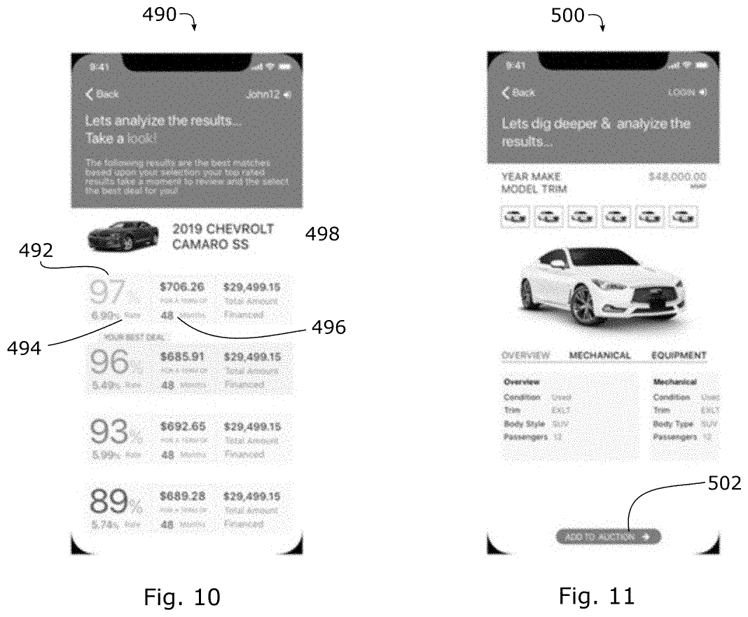

FIG. 10 shows a deal prediction screen 490 showing e.g. information about deal probability 492, interest rate 494, term 496, for a particular vehicle type 498. This prediction screen 490 may be accessed for example by swiping from the vehicle list 470.

FIG. 11 shows an information screen 500 showing information about a vehicle from the list shown in FIG. 9A. This information screen may be reached for example by clicking on a vehicle in the list of FIG. 9A or sub-list described above. In this embodiment a selection option 502 is provided to enable a customer to select the vehicle for an auction.

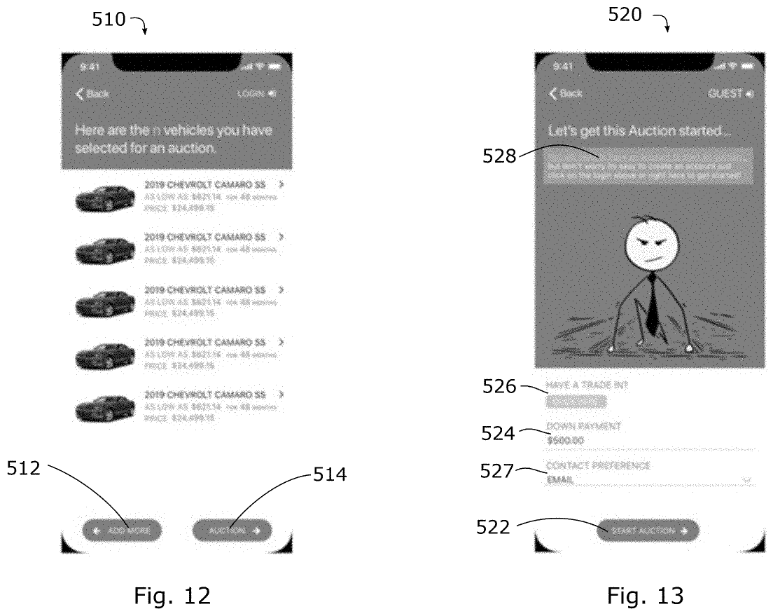

FIG. 12 shows a further list screen 510 comprising vehicles selected by the customer for example via information screen 500 or directly from vehicle list 470. A return option 512 may be provided to allow the customer to add more vehicles and a continue option 514 may be provided to allow the customer to continue to auction start screen 520 in FIG. 12. Depending on the embodiment, a single auction may be restricted to vehicles of one type to aid in comparability. The number of bids for each dealer may also be restricted.

FIG. 13 shows an auction start screen 520. Auction start screen 520 may include an auction start button 522 to start an auction requesting bids respecting the selected vehicles, and may also include data entry fields for additional information that may be used for the auction, for example a down payment field 524, and a trade in button 526 that may lead the customer to a screen (not shown) to enter trade in information. The auction start screen can also include contact information such as a contact preference 527. In this embodiment, the customer is prompted to log in or create an account with login/signup link 528 before starting the auction.

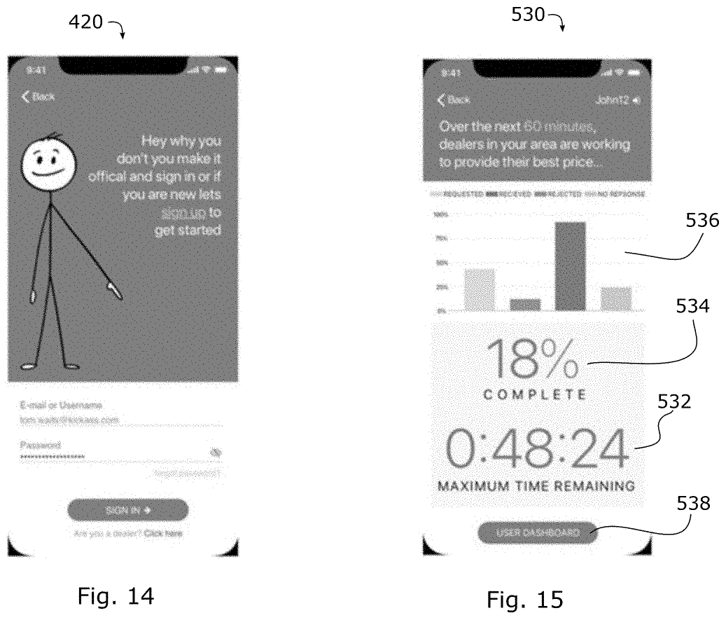

FIG. 14 shows a login/signup screen 420. The login/signup screen 420 may be presented at different stages of the process. For example, in order to avoid discouraging uninvested customers, the login/signup screen 420 may be presented late in the process, with earlier data entry screens having an option to skip by logging in. Information entered in these earlier screens may be saved and retained in the customer's account.

Once an auction is started, the customer may be directed to an auction progress screen 530 as shown in FIG. 15. In this example, auction progress screen 530 shows a remaining time 532 out of a total time period for the auction including a percentage 534 of completion of the total time period, and a chart 536 showing summarized information about bid statuses. A link 538 is provided to a customer dashboard screen that will show more information.

Dealers may input bids via a manual process, such as via the app as described below, or automatically using an API. Dealer bids can include price, but also add ons. In an embodiment, dealers verify the VIN when submitting bids.

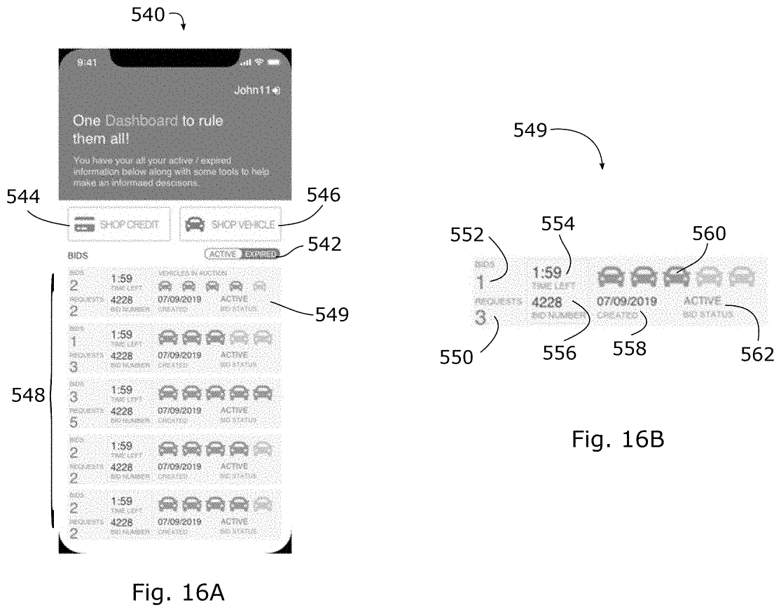

FIG. 16A shows a customer dashboard screen 540. The customer dashboard screen shows information about auctions and bids. An expired auction view button 542 may be included to allow the customer to see expired auctions; expired auctions may be defaulted when no bids are active. The dashboard screen may include additional shopping buttons 544 and 546 to allow the customer to shop and request further bids. The customer dashboard screen 540 may be the default screen shown to logged-in customers. The customer dashboard screen may include a list 548 of auctions, with information about each auction 549. FIG. 16B shows information about an auction 549 from the list 548 such as, for example, number of bid requests 550, number of bids 552, time left in auction 554, bid number 556, date auction was created 558, graphic indication of vehicles in auction 560, and bid status 562.

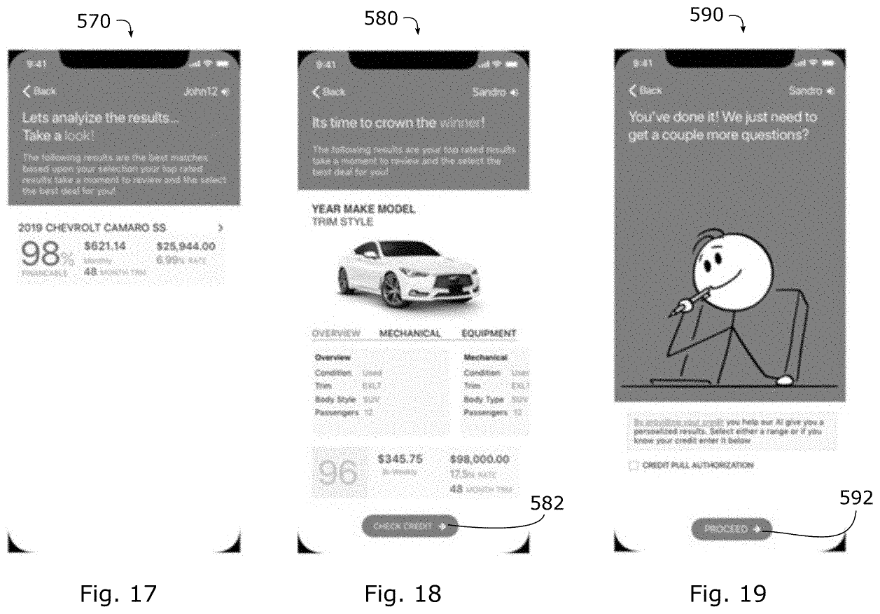

Once an auction is completed, the results may be shown in a results list 570 as shown in FIG. 17. In the example shown in FIG. 17 there is only one result. As in the deal prediction screen 490 of FIG. 10, the results list 570 may show deal prediction information, albeit with enhanced accuracy due to completed bids from the dealers setting e.g. a price. The results list 570 is a visual display of potential deals.

A further results screen 580 may show additional information about the results in the results list, as shown in FIG. 18. The customer may select a deal via this screen, e.g. by pressing check credit button 582 to continue, to send a selection of the deal to the system. Information shown may include, for example, information about the vehicle as shown on information screen 500 of FIG. 11 and deal prediction information.

To finalize a deal, a customer may be asked for additional information such as for example a confirmation of the customer's credit rating. Credit pull authorization screen 590 is shown in FIG. 19 and may be accessed for example via check credit button 582 in FIG. 18. Verification of other information such as an identity check (not shown) may also be performed. The customer may press a proceed button 592 to continue.

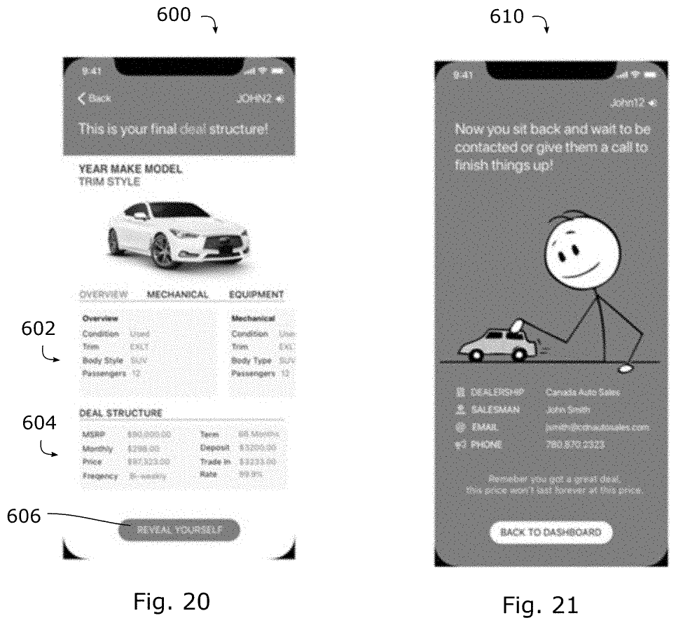

The additional information may indicate that the proposed deal is not viable. If so, the customer may be presented with a failure reporting screen (not shown) indicating this and returning the customer to an earlier step. If the information confirms that the deal is likely viable, the customer may be presented with a success reporting screen 600 as shown in FIG. 20. The success reporting screen may include vehicle information 602 and deal structure information 604.

In an embodiment, up to the success reporting screen 600 the customer may be anonymous to the dealers; the dealers may also be anonymous to the customers. In FIG. 20 a reveal yourself button 606 is provided triggering an exchange of contact information between the customer and the dealer providing the selected bid as shown in contact information screen 610 shown in FIG. 21. The customer and dealer may then finalize the deal through direct contact. In an embodiment the dealer may continue to use the system to facilitate the sending of a finance request, and to use the Services Scheduling Engine as described above. The AI may be trained based on the response of a bank to the finance request.

FIGS. 22-36 show dealer-facing app screens which may be used to manually enter bids for auctions initiated by customers via the customer-facing app screens shown in FIGS. 5-21.

FIG. 22 shows an initial screen 700 for a dealer. The dealer may be provided with conventional login screen elements such as email/username text field 702 and password text field 704. The dealer is also presented in this embodiment with an endpoint text field 706. This endpoint text field allows the dealer to enter a web link that the system can connect to obtain access to the dealer's inventory information from software at the dealership. All information on this screen may optionally be saved to allow skipping of the screen on subsequent logins.

FIG. 23 shows a dealership selection screen 710 having in this embodiment a drop down menu 712 to allow the dealer to select a dealership which they will representing in this session. The menu may be prepopulated, and may have an initial default selection, based on stored information for the user or based on the endpoint entered in text field 706.

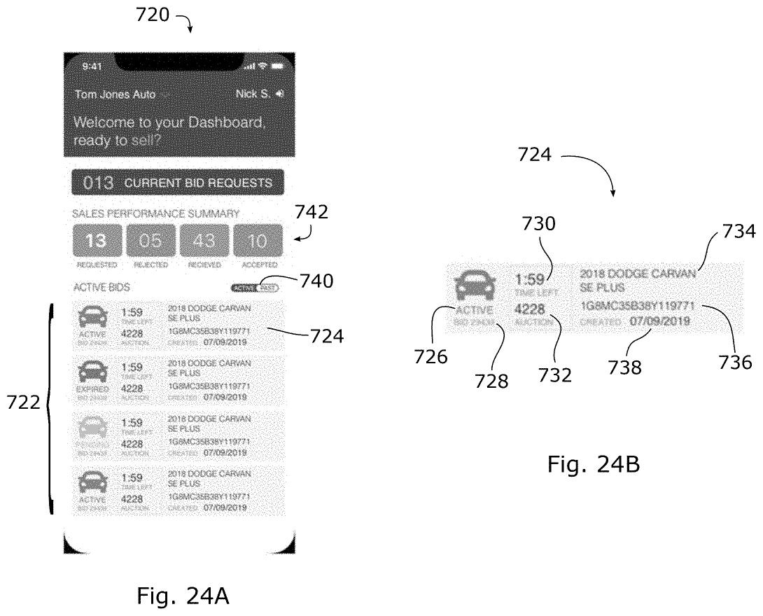

FIG. 24A shows a dealer dashboard screen 720. In this embodiment the dealer dashboard screen shows bids provided by the dealer to customers in response to bid requests. The bid requests are described in more detail above in relation to the customer-facing app screens of FIGS. 5-21. The dashboard screen here includes a list 722 of bid cards 724 representing quotes which are active or which have changed status since the dealer last used the app. The dashboard screen may also include an option 740 to see past quotes. Summary statistics 742 of current and past quotes may also be shown. FIG. 24B shows a bid card 724. The bid cards may include information about the bids, such as for example the status 726 of the bid (e.g. active, pending, expired), a bid identification number 728, remaining time 730, auction 732, make and model 734 of the vehicle, vehicle identification number 736, and date 738 at which the bid was created.

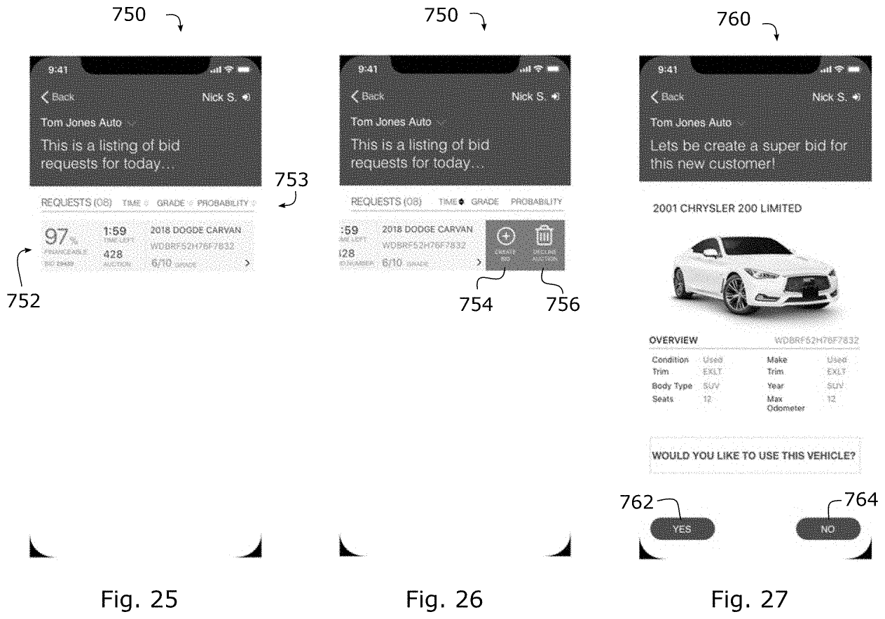

FIG. 25 shows a bid request listing screen 750. The bid request listing screen includes a list of bid requests 752. For simplicity, only one bid request 752 is shown, but more could be included. The dealer may be provided with sorting options 753 for the list, here including time left, grade, and probability that the customer's bid will be financed by a bank. Each bid request 752 may have information about the bid request shown, such as probability that the bid will be financed, time left, bid number, auction number, grade, and vehicle type.

The dealer may choose to create a bid via bid creation button 754 shown in FIG. 26. In the embodiment shown, bid creation button 754 is accessed from bid request listing screen 750 by swiping left. The dealer may also be shown a decline auction button 756 to decline the bid request.

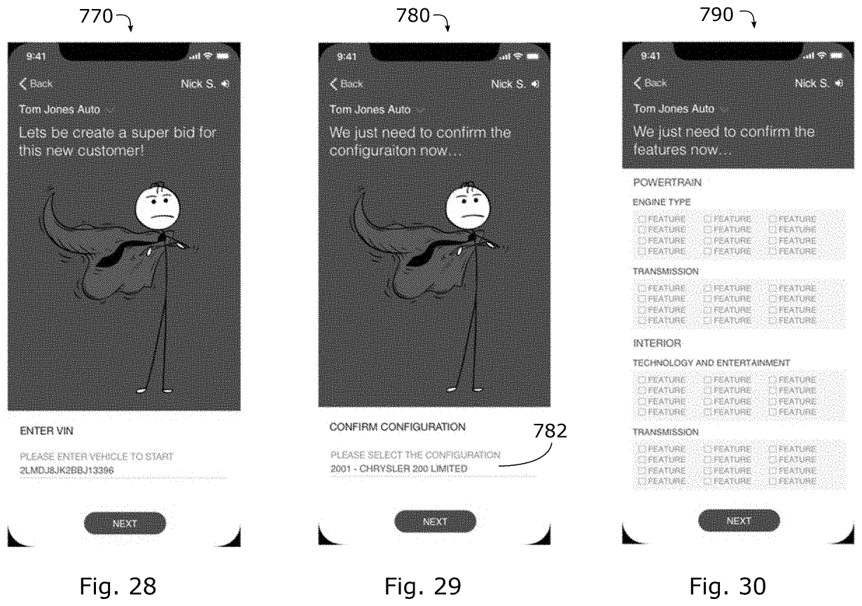

If the dealer chooses to create a bid, the dealer may be shown a bid creation screen 760 as shown in FIG. 27. The system may automatically select a vehicle from the dealer's inventory, by e.g. accessing a catalog of vehicles, generating potential deals, evaluating the potential deals and selecting a vehicle with a best evaluated deal. In this embodiment, bid creation screen 760 shows a selected vehicle with information on the vehicle and provides the dealer with a confirmation option 762 and decline option 764. The dealer may be provided with an option (not shown) to substitute the vehicle with another vehicle the same or better than the vehicle for which the bid was requested. If the dealer selects the decline option 764 the dealer may be presented with a vehicle list (not shown) of possible vehicles on which to submit a bid. If the dealer selects the confirmation option 762 the app may proceed to additional bid creation screens such as for example to VIN entry screen 770 shown in FIG. 28.

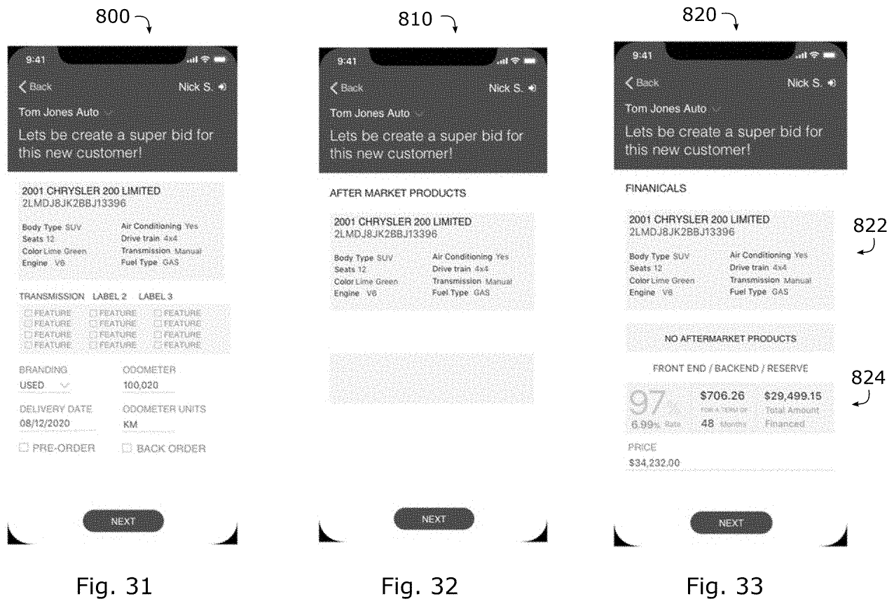

FIG. 28 shows VIN entry screen 770 providing the dealer with a text field to enter the VIN. The dealer may proceed from VIN entry screen 770 to, for example, configuration screen 780 shown in FIG. 29, where the dealer may be presented with, for example, a drop down menu 782 to select the vehicle configuration. The dealer may proceed to, for example, feature selection screen 790 shown in FIG. 30 where the dealer may select features present in the vehicle. The dealer may proceed to, for example, confirmation screen 800 shown in FIG. 31 which may show information entered at previous screens and/or additional information for confirmation by the dealer. The dealer may proceed to for example, aftermarket products screen 810 shown in FIG. 32 where the dealer may select aftermarket products such as, for example, warranties.

The system may generate potential deals based on, e.g. aftermarket product selections. In FIG. 33, a deal proposal screen 820 is shown including vehicle details 822 and deal details 824. Information can include vehicle configuration and features, warranty, financials, payment front end, back end and reserve. Details may be verified by the dealer; optionally the dealer may be provided data entry fields (not shown) to adjust the details.

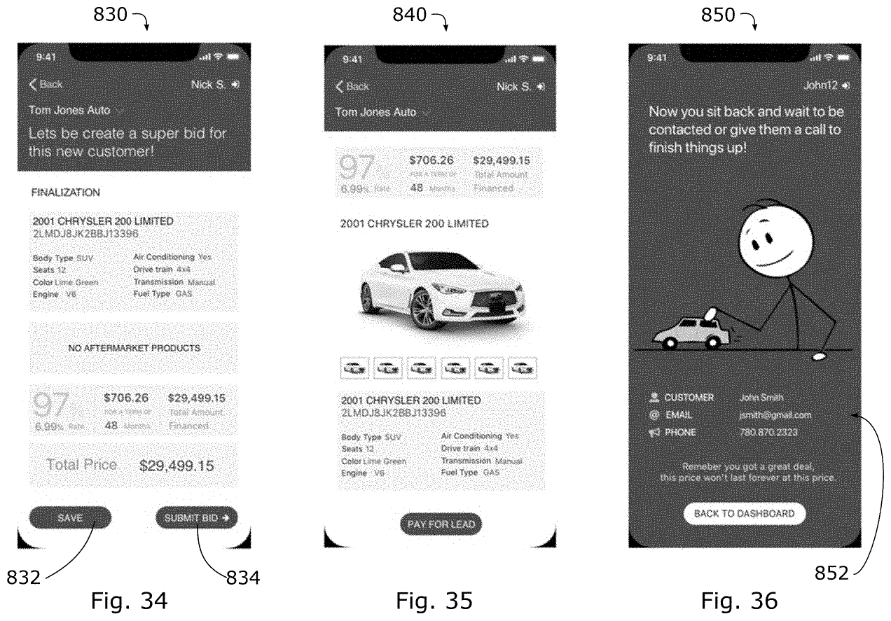

In FIG. 34, a bid submission screen 830 is shown. Details shown may be for example the same as shown in the deal proposal screen of FIG. 33. The dealer may in this embodiment save the bid using bid save button 832 or submit the bid using bid submission button 834. The customer may receive and accept the bid as described above. Once the customer has accepted the bid, the dealer may be shown a bid acceptance screen 840 as shown in FIG. 35. Bid acceptance screen 840 may be accessed for example via a notification or via the dealer's dashboard screen 720 shown in FIG. 24A. In an embodiment, the dealer may pay for this lead from the bid acceptance screen 840 and is shown customer information only after paying for the lead.

Once the dealer has proceeded from the bid acceptance screen 840, for example by paying for the lead, the dealer may be shown a customer contact screen 850, as seen in FIG. 36, showing customer information 852.

The description of FIGS. 22-36 assumes a manual process facilitated by the app. The dealer bidding process could also be automated via an API. A dealer using the API may also use the app to show relevant information about the bidding process, or to manually submit additional bids.

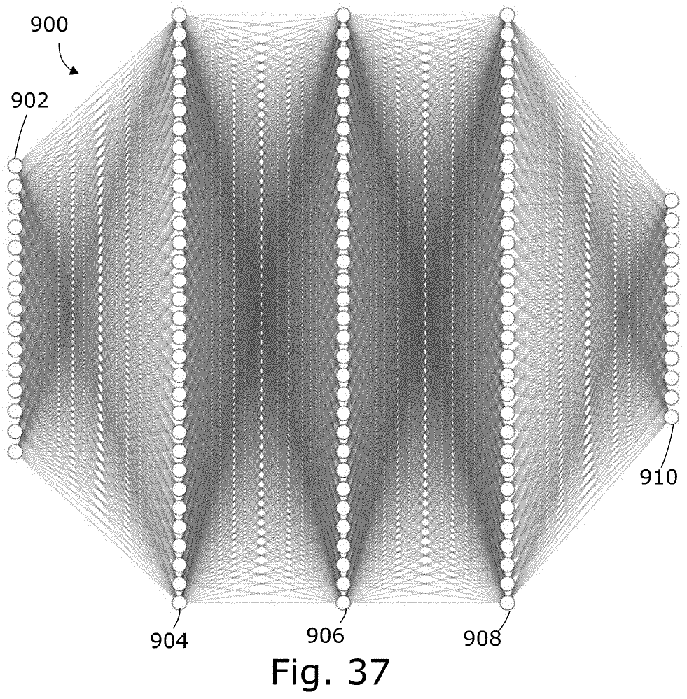

The finance prediction AI 316 may use neural networks. FIGS. 37-39 show example neural networks for a finance prediction AI 316. FIG. 37 shows a tier prediction deep neural network 900. The tier prediction deep neural network 900 may be used to generate a prediction of which lending program tier under which a lender is likely to consider a given loan request, taking into account, in this embodiment, the specifics of the customer and their order request, given a specific program from a specific lender. A first layer 902 of nodes may correspond to input data, here characteristics of the customer/request. In an example, there are 14 nodes in first layer 902 corresponding respectively to the following characteristics:
Lender
Lending program
Credit score: complete
Credit score: beacon
Credit score: risk
Undischarged bankruptcies
Repossessions
Judgements
Credit score: complete (co-applicant)
Credit score: beacon (co-applicant)
Credit score: risk (co-applicant)
Undischarged bankruptcies (co-applicant)
Repossessions (co-applicant)
Judgements (co-applicant)

The tier prediction deep neural network also includes a layer of output nodes 910. Output values at the output nodes may correspond to, for example, probabilities over each of the possible lender program tiers, each tier may for example correspond to a respective node of the layer of output nodes 910.

There may also be plural layers of intermediate nodes between the input nodes and the output nodes. For example, there may be three layers 904, 906 and 908. There could also be more or fewer layers. In an example, the intermediate layers may have 512 nodes each. FIG. 37 shows a smaller number of intermediate nodes for readability.

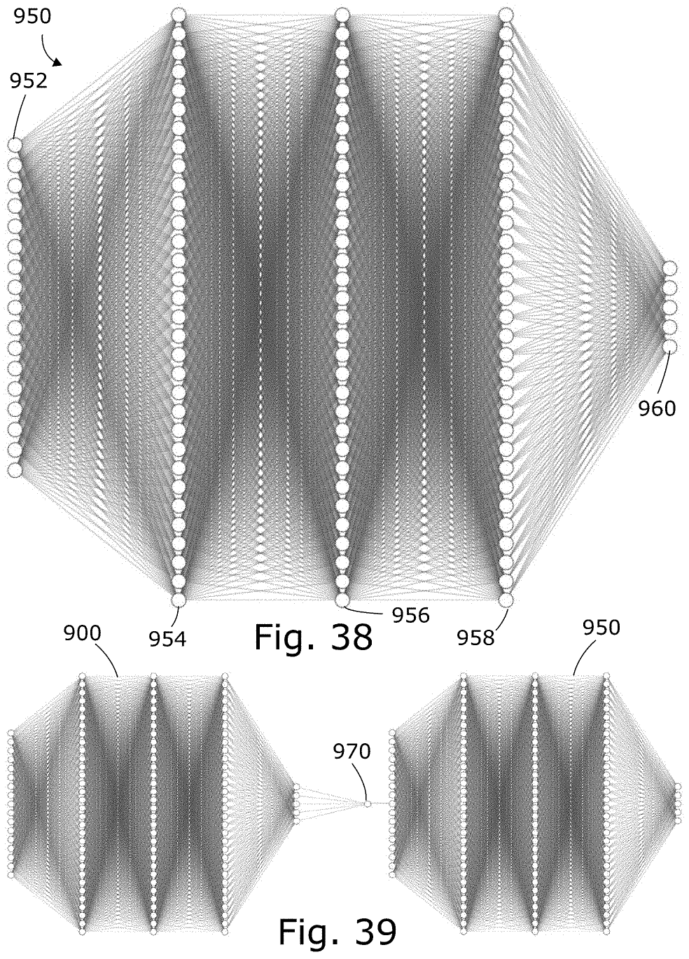

FIG. 38 shows a lender response deep neural network 950. The lender response deep neural network 950 may be used to predict the probability of the possible lender responses given customer/request characteristics and a specified lender, program, and tier (noting that the selected tier may have been output by tier prediction deep neural network 900). A first layer 952 of nodes of the lender response deep neural network 950 may correspond to inputs to the network. In an example, this first layer 952 has 17 nodes corresponding respectively to the following characteristics:
Lender
Lending program
Lending program tier
Employment income
Other income
Employment income (co-applicant)
Other income (co-applicant)
High credit utilization flag
Delinquent trades flag
Public records flag
Thin file flag
Total current instalment debt
Total current instalment debt (co-applicant)
Total current monthly instalment payments
Total current monthly instalment payments (co-applicant)
Finance amount

Lender response deep neural network 950 may also comprise a layer of output nodes 960. The output nodes may respectively correspond to, for example five possible lender responses.

There may also be plural layers of intermediate nodes between the input nodes and the output nodes. For example, there may be three layers 954, 956 and 958. There could also be more or fewer layers. In an example, the intermediate layers may have 512 nodes each. FIG. 38 shows a smaller number of intermediate nodes for readability.

The deep neural networks 900 and 950 can operate independently or together, depending on the needs of the particular customer request. FIG. 39 shows the two networks connected to feed the output of the tier prediction deep neural network 900 into the lender tier input of lender response deep neural network 950. An intermediate node 970 may store the highest likelihood prediction from the tier prediction deep neural network 900 for input as the lender tier for the of lender response deep neural network 950. Alternately, multiple possible lender tiers could be considered and a final result obtained by weighting of the outputs of the lender response deep neural network 950 for each tier by the probability of the respective tier as calculated by tier prediction deep neural network 900.

Immaterial modifications may be made to the embodiments described here without departing from what is covered by the claims.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A computer-implemented method comprising:
by one or more hardware computer processors configured with specific computer executable instructions:
receiving a set of customer parameters representing characteristics of a customer;
accessing a catalog containing data on items of a collection of items to obtain item parameters representing characteristics of specific items of the collection of items;
generating deal data elements each representing a respective potential deal, each deal data element comprising an association between loan parameters and an item of the collection of items;
operating a finance prediction AI on the deal data elements to predict responses of one or more lenders to the respective potential deals represented by the deal data elements for the customer;
associating the deal data elements with evaluation scores representing evaluations of the respective potential deals according to an evaluation metric taking into account the predicted bank responses; and
selecting a subset of the deal data elements based on the evaluation scores and displaying a visual representation of the respective potential deals represented by the subset of deal data elements on a display device.

2. The computer-implemented method of claim 1 comprising:
receiving on an input device a selection signal indicating one of the respective potential deals to select the deal data element representing the potential deal indicated by the selection signal;
transmitting a financing request corresponding to the selected deal data element to one or more lenders;
receiving a financing offer representing a response to the loan requests from the one or more lenders; and
displaying a visual representation of the financing offer on the display device.

3. The computer-implemented method of claim 2 comprising updating the finance prediction AI based on the financing request and financing offer.

4. The computer-implemented method of claim 1 or claim 2 in which the evaluation metric also takes into account an expected desirability of the potential deal to the customer.

5. The computer-implemented method of claim 4 in which the expected desirability of the potential deal to the customer is based on the customer parameters.

6. The computer-implemented method of claim 5 in which the customer parameters include preferences indicated by the customer.

7. The computer-implemented method of claim 1 in which the evaluation metric also takes into account a profit breakdown.

8. The computer implemented method of claim 1 comprising before generating the deal data elements, operating the finance AI on the customer parameters to generate a set of financeability bounds for the customer, and in generating deal data elements, the deal data elements being generated within the financeability bounds.

9. A computer-implemented method comprising:
by one or more hardware computer processors configured with specific computer executable instructions:
receiving a set of customer parameters representing characteristics of a customer;
accessing a catalog containing data on items of a collection of items to obtain item parameters representing characteristics of specific items of the collection of items;
generating deal data elements each representing a respective potential deal, each deal data element comprising an association between loan parameters and an item of the collection of items;
operating a finance prediction AI on the deal data elements to predict responses of one or more lenders to the respective potential deals represented by the deal data elements for the customer;
associating the deal data elements with evaluation scores representing evaluations of the respective potential deals according to one or more evaluation metrics taking into account the predicted bank responses; and
displaying on a display device a visual representation of the respective potential deals visually associated with their evaluations according to the one or more evaluation metrics.

10. A system comprising:
an input channel for receiving customer parameters representing characteristics of a customer;
a catalog containing data on items in a collection of items;
a deal generator connected to the catalog to generate deal data elements each representing a respective potential deal, each deal data element comprising an association between loan parameters generated by the deal generator and an item of the collection of items;
a finance prediction AI connected to the deal generator and to the input channel to generate offer predictions predicting responses of one or more lenders to financing requests for the potential deals represented by the deal data elements for the customer;
an evaluator connected to the finance prediction AI to select a subset of the deal data elements representing potential deals on items of the collection of items, based on evaluation scores for the potential deals according to an evaluation metric taking into account the offer predictions;
the evaluator being connected to an output channel for transmitting a representation of the selection of deals for visual display.

11. The system of claim 10 in which the finance prediction AI is also configured to generate a set of financeability bounds for the potential item purchaser based on the customer information, and the deal generator is connected to the finance prediction AI to generate deals within the financeability bounds.

12. The system of claim 10 wherein
said evaluator or a second evaluator is connected to the finance prediction AI to generate evaluation scores for the deal data elements representing potential deals on items of the collection of items, based on evaluation scores for the potential deals according to an evaluation metric taking into account the offer predictions; and
wherein the evaluator is configured for transmitting a representation of the potential deals for visual display and visually associated with their evaluations according to the one or more evaluation metrics.
